(19) United States
(12) Patent Application Publication
(10) Pub. No.: US 2011/0291387 A1
(43) Pub. Date: Dec. 1, 2011

(54) FOLDABLE WHEELCHAIR

(76) Inventor: Yuan-Chieh CHANG LIAO, Taichung City (TW)

(21) Appl. No.: 12/788,275

(22) Filed: May 26, 2010

(51) Int. Cl. A61G 5/08

(52) U.S. Cl. 280/647

(57) ABSTRACT

A foldable wheelchair includes a pair of front legs, a pair of rear legs, a seat frame, a dual-hinge joint, and a pair of armrests. A front pivoting means is pivotally connected to the seat frame and the front legs. A rear pivoting means is pivotally connected to the seat frame and the rear legs. A bottom of the dual-hinge joint is pivotally connected to a rear of the seat frame. A top of the dual-hinge joint is pivotally connected to a backrest body. Therefore, the front legs can be folded backward by the front pivoting means and the rear legs can be folded forward by the rear pivoting means. The tilt angle of the backrest body can be adjusted and the backrest body can be folded forward. Thereby the volume of the wheelchair can be reduced.

### BACKGROUND OF THE INVENTION

1. Field of the Invention

The present invention relates to a wheelchair, more particularly to a wheelchair in which front legs and rear legs can be folded and a backrest body can be tilted or folded forward to reduce the whole volume of the wheelchair for the convenience of transport, packing and storage.

2. Related Prior Art

A conventional wheelchair, medical chair or bathing chair is designed for disabled people, as shown in FIG. 1. A conventional wheelchair 10 has a pair of front legs 11, a pair of rear legs 12, a seat frame 13 and a backrest body 14. Each of the front legs 11 has a wheel 111 at its bottom. Each of the rear legs 12 has a wheel 121 at its bottom. The wheels 111, 121 can be small or large wheels. The conventional wheelchair 10 usually has a non-foldable configuration which occupies space in storage.

Another conventional wheelchair 100, as shown in FIG. 2, has a seat frame 101, a pair of front legs 110 and a pair of rear legs 120. Underneath the seat frame 101, a collapsible structure 102 can be folded to move the front legs 110 and rear legs 120 toward the center line of the wheelchair so as to reduce the size for storage. However, only the width thereof can be reduced, leaving the height of the while wheelchair unchanged. This still occupies space, causing inconvenience in storage, transport or packing.

Therefore, there is a need of novel wheelchair which overcomes the above shortages.

### SUMMARY OF THE INVENTION

One object of the invention is to provide a foldable wheelchair in which front legs can be folded backward and rear legs can be folded forward.

Another object of the invention is to provide a foldable wheelchair in which a backrest body can be folded forward to further reduce the whole wheelchair.

Still another object of the invention is to provide a foldable wheelchair in which the tilt angle of a backrest body can be adjusted.

In order to achieve the above and other objectives, a foldable wheelchair of the invention includes:

a pair of front legs, connected to each other by at least one front rod, a front wheel being mounted on a bottom of each front leg, and a front pivoting means being pivotally connected to a front of a seat frame;

a pair of rear legs, connected to each other by at least one rear rod, a rear wheel being mounted on a bottom of each rear leg, and a rear pivoting means being pivotally connected to a rear of a seat frame;

the seat frame, pivotally connected to the front legs and the rear legs;

a dual-hinge joint, pivotally connected to a rear of the seat frame at its bottom and to a backrest body at its top;

the backrest body, pivotally connected to the dual-hinge joint with an adjustable tilt angle; and

a pair of armrests, pivotally connected to the backrest body in a manner to be able to flip up;

wherein the front legs are foldable backward by the front pivoting means, the rear legs are foldable forward by the rear pivoting means, the angle of the backrest body is adjustable and foldable forward by the dual-hinge joint.

Other objectives, advantages and features of the present invention will become apparent from the following description referring to the attached drawings.

### BRIEF DESCRIPTION OF THE DRAWINGS

The present invention will be described via detailed illustration of the preferred embodiment versus prior art referring to the drawings where:

FIG. 1 is a schematic perspective view of a conventional wheelchair;

FIG. 2 is a schematic perspective view of a conventional wheelchair;

FIG. 3 is a schematic exploded view of a wheelchair according to one embodiment of the invention;

FIG. 4 is a schematic assembled view of a wheelchair according to one embodiment of the invention;

FIG. 5 is a schematic plan view of a wheelchair according to one embodiment of the invention;

FIG. 6 is a cross-sectional view of a stopper and a ratchet of a dual-hinge joint in wheelchair according to one embodiment of the invention;

FIG. 7 is a cross-sectional view showing the stopper leaving the ratchet of a dual-hinge joint according to one embodiment of the invention;

FIG. 8 is a schematic plan view showing the adjustment of a tile angle of the dual-hinge joint according to one embodiment of the invention;

FIG. 9 is a cross-sectional view of front elastic beads and elastic sheets of a front pivoting means according to one embodiment of the invention;

FIG. 10 is a schematic plan view of a front pivoting means according to one embodiment of the invention;

FIG. 11 is a schematic plan view of a rear pivoting means according to one embodiment of the invention;

FIG. 12 is a schematic plan view showing the pivoting state of bottoms of a dual-hinge joint according to one embodiment of the invention;

FIG. 13 is a schematic plan view of a wheelchair in folded state according to one embodiment of the invention;

FIG. 14 is a schematic plan view of a wheel chair with large rear wheels according to one embodiment of the invention;

FIG. 15 is a schematic plan view of a wheel chair with large rear wheels in folded state according to one embodiment of the invention;

FIG. 16 is a schematic plan view of a rear pivoting means according to another embodiment of the invention; and

FIG. 17 is a schematic plan view of a rear pivoting means in pivoting state according to one embodiment of the invention.

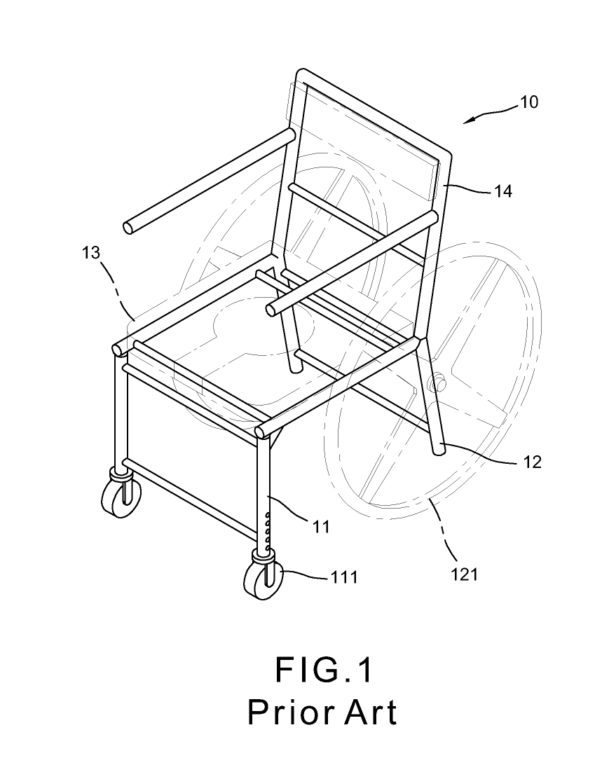

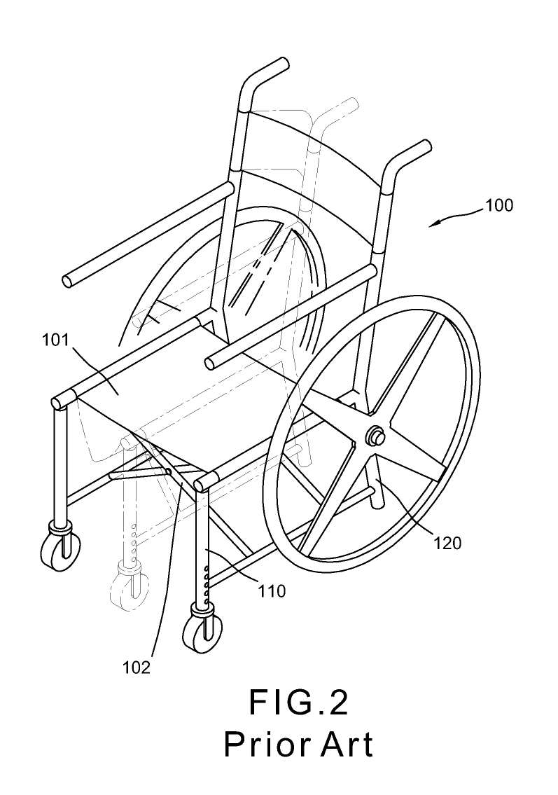

### DETAILED DESCRIPTION OF THE INVENTION

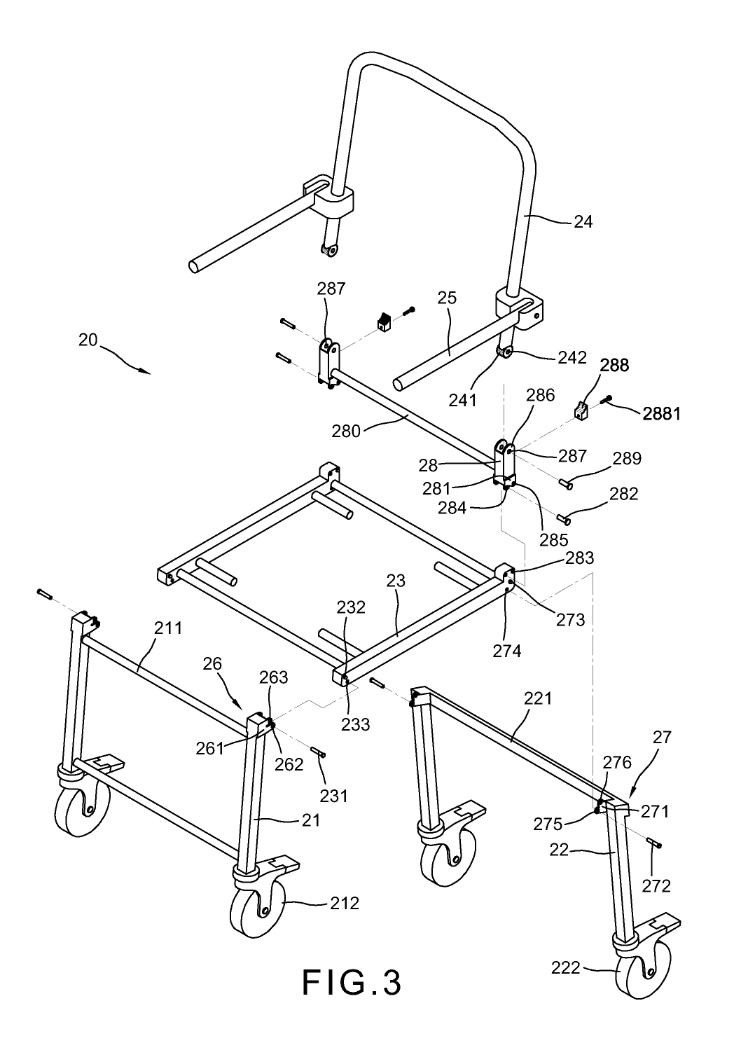

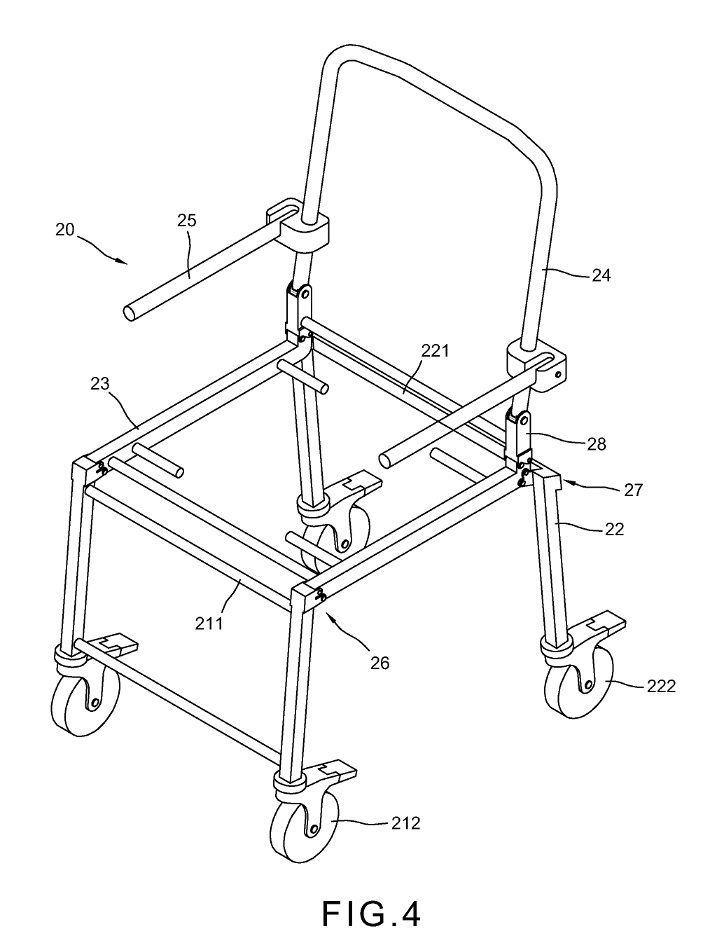

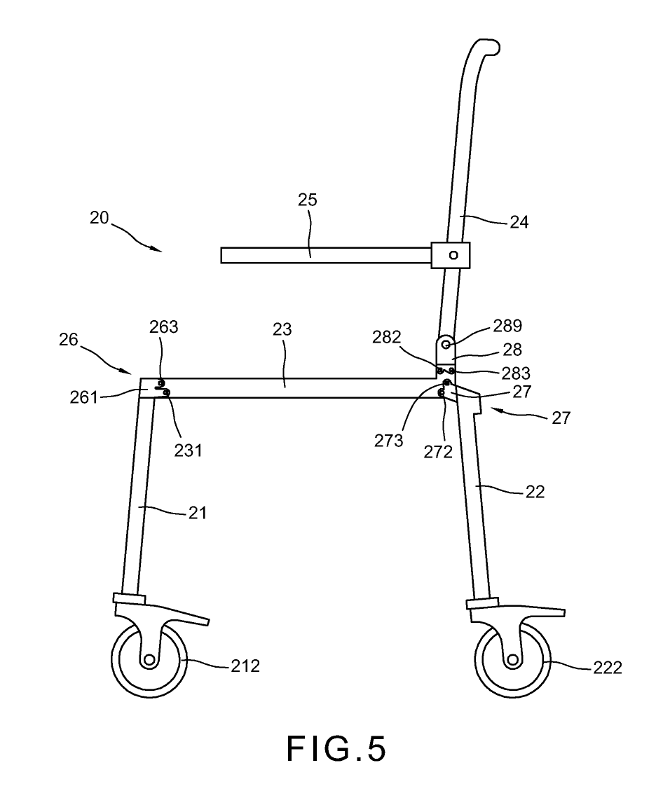

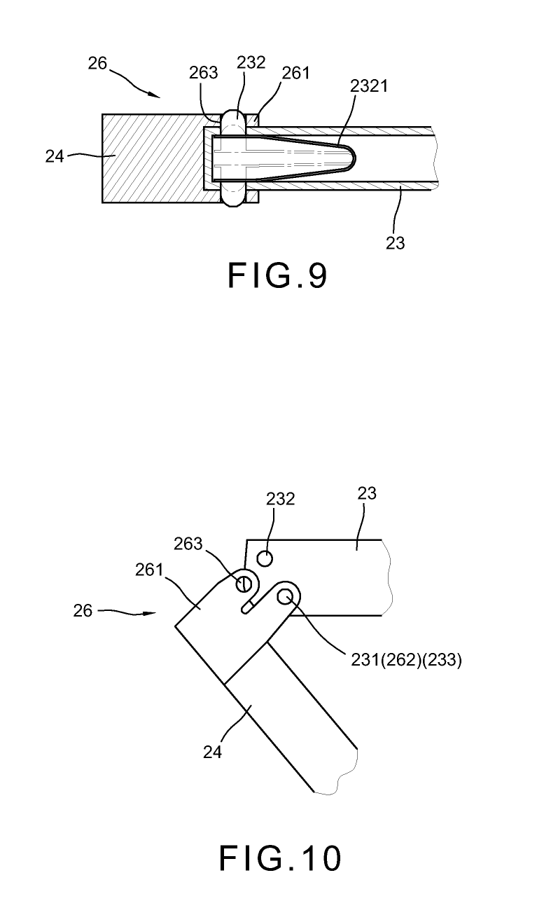

As shown in FIG. 3 through FIG. 10, a foldable wheelchair of the invention includes a pair of front legs 21, a pair of rear legs 22, a seat frame 23, a backrest body 24, a pair of armrests 25, and a dual-hinge joint 28. The seat frame 23 is of rectangular shape and can have a cushion or medical toilet seat (not shown) thereon. The pair of front legs 21 is pivotally connected to a front of the seat frame 23. The front legs 21 are connected to each other through their corresponding front rods 211 and each of them has a front wheel 212 at its bottom. A front pivoting means 26 is located on a top of each of the front leg 21 for pivotally connecting the corresponding leg 21 to a front part of the seat frame 23 as shown in FIG. 3, FIG. 9, FIG. 10. The front pivoting means 26 includes a pair of front pivoting sheets 261 each of which further has a front pivoting hole 262 and a front positioning hole 263. The seat frame 23 further has a pair of front pivoting studs 231 and a pair of front elastic beads 232. Each of the front pivoting studs 231 penetrates through an axial hole 233 at a front of the corresponding front leg 23 to pivotally connect to the front pivoting hole 262, while each front elastic bead 232 is embedded into the corresponding positioning hole 263. Each of the front elastic beads 232 has an elastic sheet 2321 therein as shown in FIG. 9, so that the front bead 232 can return to its original state after being pressed. The pressed front elastic beads 232 allow the front legs 21 to fold backward.

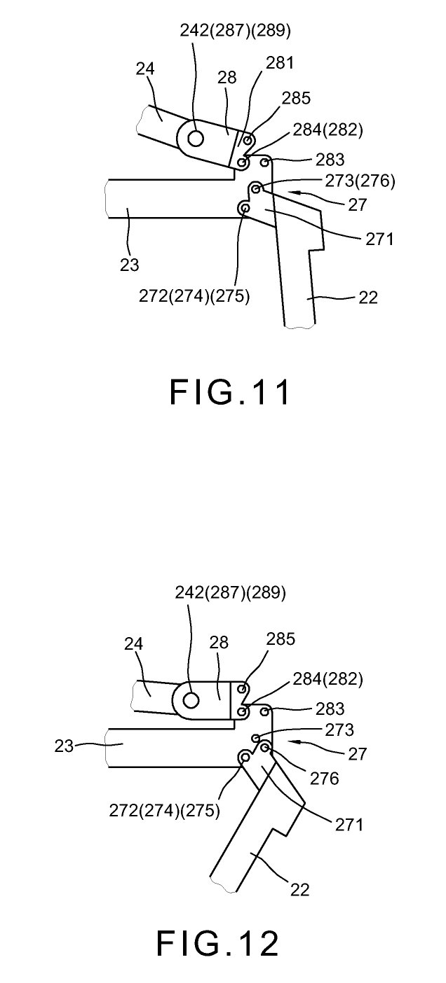

A pair of rear legs 22 is located at a rear of the seat frame 23. Each of the rear legs 22 has a width greater than the front legs 21, so that the rear legs 22 will not contact the front legs 21 when the wheelchair is folded. The rear legs 22 have one or two rear rods 221 to connect to each other. Each of the rear legs 22 has a rear wheel 222 at its bottom. The rear wheels can be small or large wheels, even though small wheels are used in some embodiments of the invention. A rear pivoting means 27 is located at an intersection of a rear of the seat frame 23 and a top of each rear leg 22, as shown in FIG. 3, FIG. 11, and includes a rear pivoting sheet 271 at each rear leg 22, a rear pivoting stud 272 at the seat frame 23, an axial hole 274 and a rear elastic bead 273. The rear pivoting stud 272 penetrates through the axial hole 274. The rear pivoting sheet 271 has a rear pivoting hole 275 and a rear positioning hole 276. The rear pivoting stud 272 is pivoting connected to the rear pivoting hole 275, and the rear elastic bead 273 is embedded into the rear positioning hole 276. Inside each of the rear elastic beads 273 is located an elastic sheet which is the same as the elastic sheet 2321 of the front pivoting means 26 shown in FIG. 9, so that the rear bead 273 can return to its original state after being pressed. The pressed rear elastic beads 273 allow the rear legs 22 to fold forward.

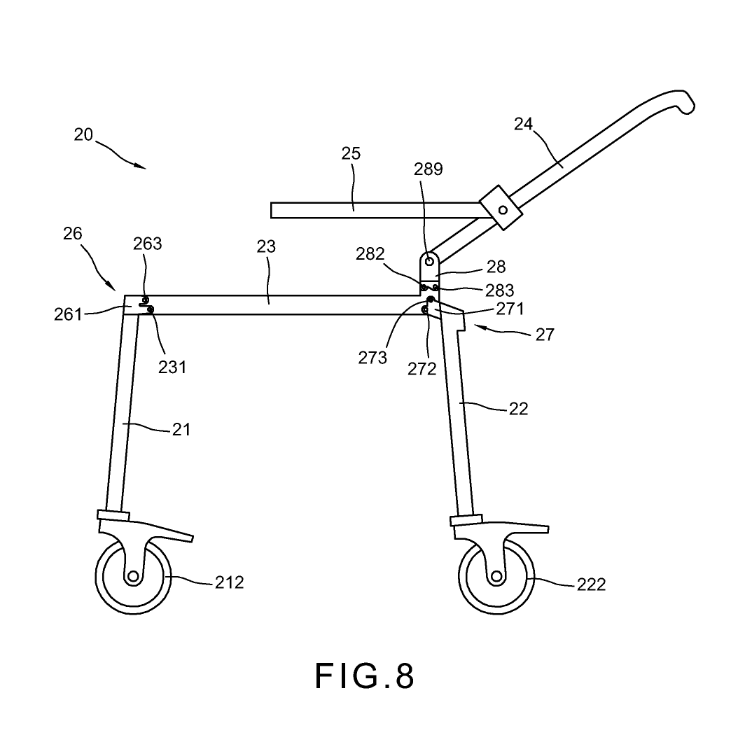

The dual-hinge joint 28 as shown in FIG. 3 and FIG. 12 is a joint having an upper hinge and a lower hinge. A connecting rod 280 connects the upper hinge to the lower hinge so that the two hinges can work simultaneously. Both of the upper hinge and the lower hinge are pivotally connected to the rear of the seat frame 23 at their bottoms and to the backrest body 24 at their tops. Each of the bottoms of the upper hinge and the lower hinge includes a lower pivoting sheet 281, a pivoting stud 282 and an elastic bead 283. The lower pivoting sheet 281 has a lower pivoting hole 284 and a lower positioning hole 285. The pivoting stud 282 is pivoting connected to the lower pivoting hole 284 and the elastic bead 283 is embedded into the lower positioning hole 285. The elastic bead 283 has an elastic sheet therein, like the elastic sheet 2321 of the front pivoting means 26 shown in FIG. 8 to give the elastic bead 283 the elastic force to return to its original state after being pressed. The pressed elastic beads 282 allow the dual-hinge joint 28 to fold forward.

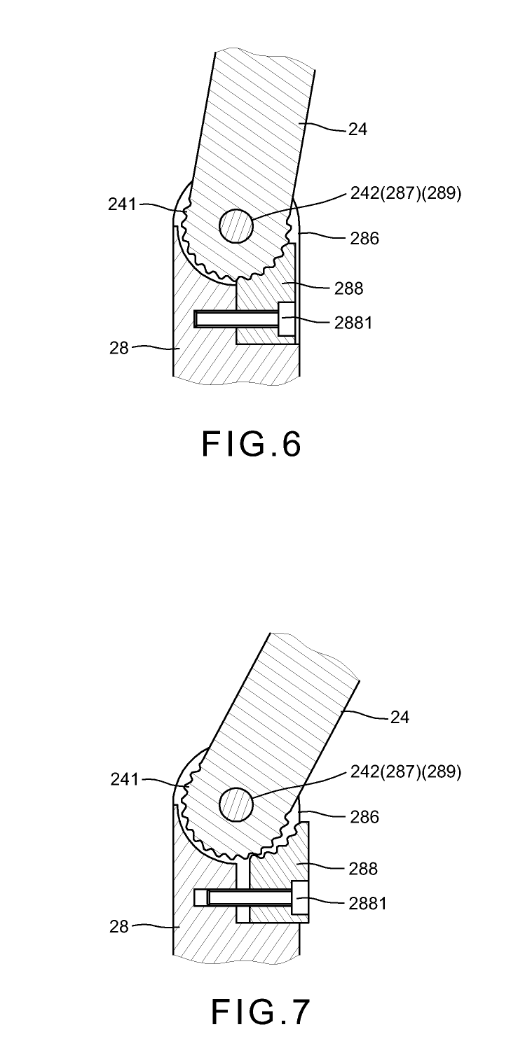

As shown in FIG. 3, FIG. 6, FIG. 7, each of the tops of the upper hinge and the lower hinge of the dual-hinge joint 28 has an upper pivoting sheet 286, an upper pivoting hole 287 and a stopper 288. The backrest body 24 is a reversed U-shaped rod, and has a ratchet 241 and a through hole 242 at its bottom. An axial stud 289 penetrates through the upper pivoting hole 287 of the dual-hinge join 28 and the through hole 242 of the backrest body 24. The stopper 288 is located inside the upper pivoting sheet 286 and is driven to move by a screw stud 2881. Specifically, the screw stud 2881 penetrates through the stopper 288 in a manner to allow the upper pivoting sheet 286 of the dual-hinge joint 28 to shift back and forth. The action of the shifted screw stud 2881 driving the stopper 288 to engage the ratchet 241 of the backrest body 24 will determine the tilt angle of the backrest body 24 and therefore the forward or backward angle of the backrest body 24. Each side of the backrest body 24 is pivotally connected to a armrest 25 in a manner to be flip up as known in the art.

According to the configuration of the invention, when a user would like to fold up the foldable wheelchair, the front elastic beads 232 of the front pivoting means 26 is pressed down to have the elastic beads 232 leave the front positioning holes 263 of the front leg 21. Then the front legs 21 are folded backward using the front pivoting studs 231 as their folding centers. Subsequently, the rear elastic beads 273 of the rear pivoting means 27 are pressed down to have the rear elastic bead 273 leave the front positioning holes 276 of the rear legs 22. The rear legs 22 are folded forward using the rear pivoting studs 272 as their folding center. After the front legs 21 are folded, the rear legs 22 are folded in a manner not to contact with the front legs 21.

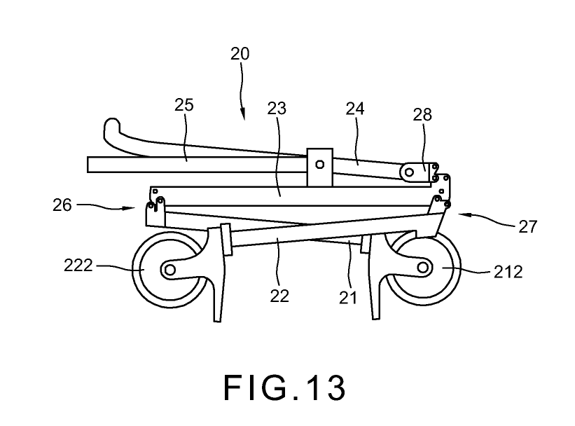

Furthermore, the armrests 25 are lifted upward to around the position parallel to the backrest body 24. Then, the elastic beads 283 of the dual-hinge joint 28 is pressed down to have the elastic beads 282 leave the lower positioning hole 285 of the dual-hinge joint 28. The backrest body 24 and the dual-hinge joint 28 are folded forward using the pivoting stud 282 as their pivoting centers so that the backrest body 24 and the dual-hinge joint 28 are about in parallel to the seat frame 23 as shown in FIG. 13. Thereby, a folding operation is finished, reducing the volume of the whole wheelchair.

The dual-hinge joint 28 allows the backrest body 24 to fold forward, and also allows the tilt angle of the backrest body 24 to be adjustable. As shown in FIG. 6 and FIG. 7, when in use, the screw stud 2881 is adjusted outward to drive the stopper 288 not to engage with the ratchet 241. After the tilt angle of the backrest body 24 needs to adjusted, the screw stud 2881 is tightened up to drive the stopper 288 to engage with the ratchet 241 of the backrest body 24. The backrest body 24 is thereby positioned at that tilt angle.

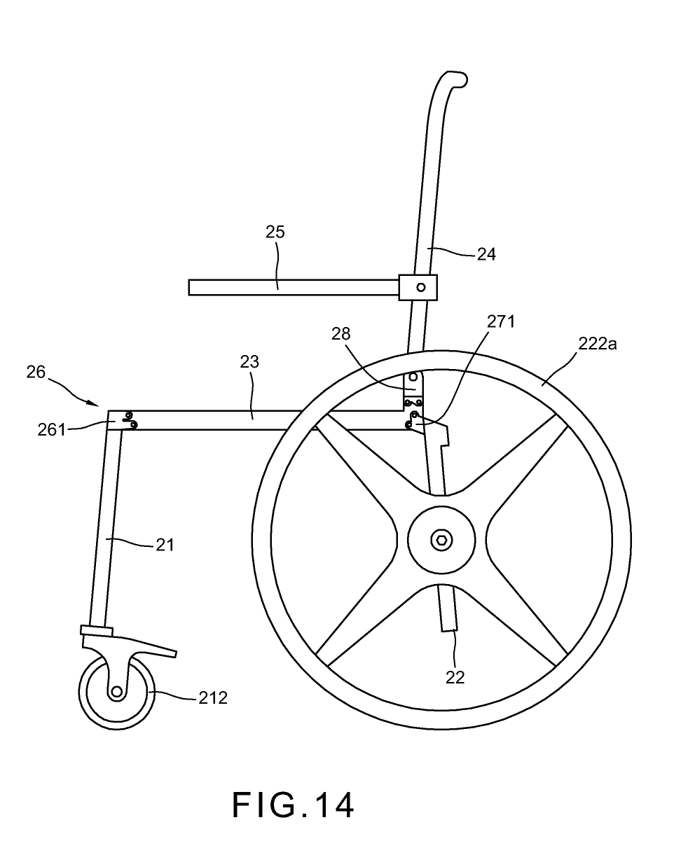

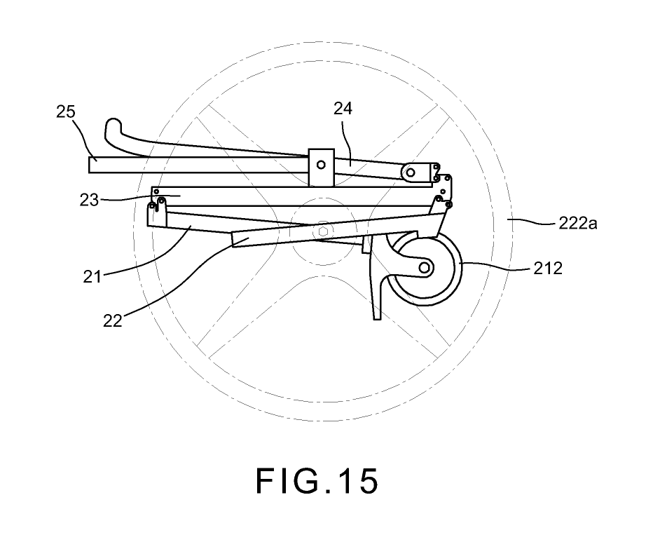

As shown in FIG. 14 where the rear wheels 222a of the rear legs 22 are large wheels, the folding operation is the same as the above as shown in FIG. 15.

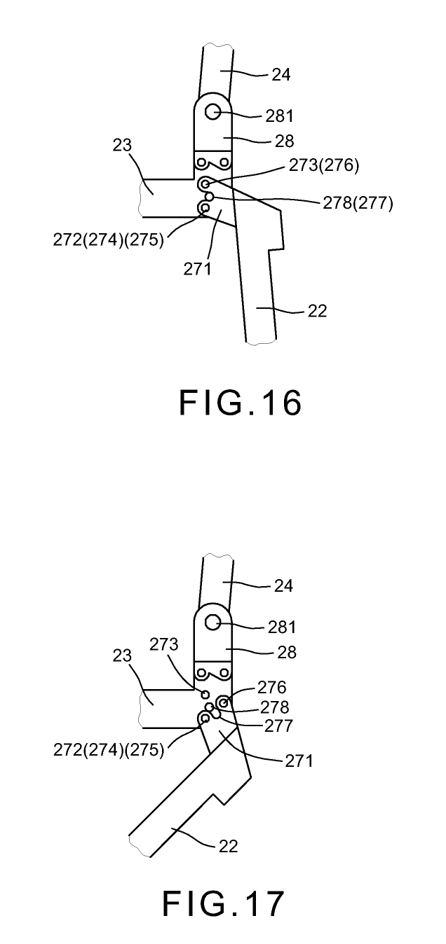

In FIG. 16 and FIG. 17 which illustrate another embodiment of the invention, a curved engaging slot 277 is further mounted to one or both rear pivoting sheets 271 of the rear legs 22. The seat frame 23 further has at least one engaging stud 278. When the rear legs 22 are unfolded, the rear elastic beads 273 are embedded into the positioning holes 276, at least one engaging stud is also embedded into the engaging slot 277 to enhance the structure strength.

Furthermore, the front pivoting means 26, the rear pivoting means 27 and the dual-hinge joint 28 respectively can be applied with elastic device or elastomer gel which provides effect of shock absorbing.

The wheelchair of the invention in folded form has significantly reduced height. The conventional wheelchair in folded form cannot have reduced height but width. Compared to the prior art, the wheelchair of the invention offer more convenience in transport, packing and storage.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A foldable wheelchair, comprising:
a pair of front legs, connected to each other by at least one front rod, a front wheel being mounted on a bottom of each front leg, and a front pivoting means being pivotally connected to a front of a seat frame;
a pair of rear legs, connected to each other by at least one rear rod, a rear wheel being mounted on a bottom of each rear leg, and a rear pivoting means being pivotally connected to a rear of a seat frame;
the seat frame, pivotally connected to the front legs and the rear legs;
a dual-hinge joint, pivotally connected to a rear of the seat frame at its bottom and to a back frame at its top; and
a pair of armrests, pivotally connected to the back frame in a manner to be foldable;
wherein the front legs are foldable backward by the front pivoting means, the rear legs are foldable forward by the rear pivoting means, the angle of the back frame is adjustable and foldable forward by the dual-hinge joint.

2. The foldable wheelchair of claim 1, wherein the front pivoting means comprises a pair of front pivoting sheets on the front legs, front pivoting studs, axial holes and front elastic beads on the seat frame, the front pivoting sheets further respectively have a front pivoting hole and a front positioning hole, the front pivoting studs are in the axial holes to pivotally connect to the front pivoting hole, the front elastic beads are embedded into the front positioning hole, the front elastic beads respectively have an elastic sheet to allow the front elastic beads to return their original states after being pressed.

3. The foldable wheelchair of claim 1, wherein the rear pivoting means further comprises a rear pivoting sheet on each rear leg, and rear pivoting studs, axial holes and rear elastic beads on the seat frame, the rear pivoting sheet has a rear pivoting hole and a rear positioning hole, the rear pivoting studs are in the axial holes to pivotally connect to the pivoting holes, the rear elastic beads are embedded into the rear positioning holes, the rear elastic beads respectively have an elastic sheet to allow the rear elastic beads to return their original states after being pressed.

4. The foldable wheelchair of claim 1, wherein at bottoms of the dual-hinge joint are a pair of lower pivoting sheets, pivoting studs and elastic beads on the seat frame, the lower pivoting sheets respectively have a lower pivoting hole and a lower positioning hole, the pivoting studs are pivotally connected to the lower pivoting holes, the elastic beads are embedded into the lower positioning holes, the elastic beads have elastic sheets to allow the elastic beads to return their original states after being pressed.

5. The foldable wheelchair of claim 1, wherein at the top of the dual-hinge joint are an upper pivoting sheets, an upper pivoting hole and a stopper, at a bottom of the back frame are a ratchet and a through hole, an axial stud penetrates through the upper pivoting hole and the through hole, the stopper is located inside the upper pivoting sheet and is driven to move by a screw stud, the screw stud is combined to the top of the dual-hinge joint for shifting the screw stud to drive the stopper to engage with the ratchet.

6. The wheelchair of claim 1, wherein the rear pivoting means further comprises a pair of pivoting sheets on the rear legs, and rear pivoting studs, stoppers and rear elastic beads on the seat frame, the rear pivoting sheets respective have a rear pivoting hole, a curved engaging slot and a rear positioning hole, the rear engaging stud is pivotally connected to the rear pivoting hole, the stopper is in the engaging slot, the rear elastic beads are embedded in the rear positioning holes, the rear elastic beads respectively have an elastic sheet to allow the rear elastic beads to return their original states after being pressed.

7. The foldable wheelchair of claim 1, wherein the dual-hinge joint has a connecting rod.
